(19) United States
(12) Patent Application Publication
(10) Pub. No.: US 2002/0111967 A1
(43) Pub. Date: Aug. 15, 2002

(54) Server for providing user with information and service, relay device, information providing method, and program

(75) Inventor: Tomoki Nagase, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,688

(22) Filed: Mar. 22, 2002

(30) Foreign Application Priority Data
Feb. 11, 2001 (JP) 2001-338480

(51) Int. Cl. G06F 17/20; G06F 15/16; G06F 15/00

(52) U.S. Cl. 707/513; 709/203; 709/246; 707/540; 704/8

(57) ABSTRACT

A server transmitting display information for specifying a display content on a terminal device in response to request information given from the terminal device, includes a communication module receiving the request information from the terminal device on a network, and the transmitting the display information for specifying the display content on the terminal device, and an embedding module embedding a customizing area containing information display functions for displaying information provided on the network or service gateway functions to services provided on the network, into the display content.

### BACKGROUND OF THE INVENTION

The present invention relates to a technology of providing users with information and services via a network, and also to a technology of translating the information distributed.

An Internet service provider (that will hereinafter be abbreviated to an ISP) receives the information provided from a user (who may be called a member) and desired to be disclosed on the Internet by this user, and registers the same information as a Web page. The conventional ISP used to distribute the Web page to a browsing user through a Web server without modifying a content of the Web page provided from the user.

On the other hand, the Internet is connected to networks, servers or terminals existing world over without barriers of the borders. Accordingly, the user is able to transmit the user's own information the world over simply by utilizing the Internet and the Web server as well.

Further, the organization such as the enterprise makes the use of Intranet that connects in-office servers and terminals to each other separately from the open Internet.

### SUMMARY OF THE INVENTION

services such as multiple searches, translations, news distributions and others are provided on the Internet. These services can be utilized by accessing those service providing sites. It is not, however, simple for each provider of the Web page to enjoy those services from the provider's own Web page. If those services (functions) can be embedded into a transmission-sided page, the versatility of the Internet is remarkably enhanced, however, there was, though disappointed, no existence of ISP for providing those functions.

Moreover, even if the information is transmitted over the world, such pieces of information are not necessarily understandable to people at every corner of the world because of barriers of languages. For example, even when the user desires to get the Web page created in Japanese to be browsed overseas, the browsing persons who can comprehend this Web page are limited.

By contrast, even when the user desires to read a Web page transmitted from a foreign country, the barrier of the language is not easy to remove, and the understandable Web pages are also limited. Further, for example, even though described in a language like English understandable to a comparatively large number of Japanese people, they might feel it difficult linguistically to smoothly comprehend a multiplicity of Web pages. In such a case, it must be helpful to utilize a machine translation service on the Internet, however, the reader of the Web page has hitherto needed preparing the machine translation platform (environment). Namely, the Web page reader must prepare translation software in order to configure the machine translation platform. Further, there is also required a computer implementing hardware resources enough not to feel a time-consuming machine translation process stressful. Then, some costs are required for obtaining such pieces of software and hardware. Hence, no Web page was browsed by the readers who could neither afford nor desired to expend the costs. Hence, if a profit obtained corresponding to an access count of the Web page is applied to a fund for administering the Web page, some Web page administrators fell into such a situation that they had no alternative but to give up the continuation of administering the Web pages due to an insufficient access count to each Web page.

Moreover, it was not easy for the ISP to embed the services (functions) described above into the Web page (on the information transmitting side) created by the information provider. Further, the ISP needs a further increase in the number of members in order to continuously operate the services, however, it was difficult to provide the services differentiated from those of other ISPs.

Further, for instance, a service sector in the enterprise had a desire for providing the services similar to those described above on an in-office private network as on the Internet. It was, however, difficult to actualize those services.

Accordingly, it is a primary object of the present invention, which was devised to obviate the problems inherent in the prior art, to provide a technology capable of enhancing a usability of a user's own Web page by embedding on-network services (functions) into the user's own Web page when the user (information provider) of the network transmits the information through on the Web page and so forth.

It is another object of the present invention to provide a technology capable of increasing a probability in which the Web page is browsed.

It is a further object of the present invention to provide a technology capable of increasing the number of members by differentiating a network service provider from other service providers.

To accomplish the above objects, according to one aspect of the present invention, a server transmitting display information for specifying a display content of a terminal device in response to request information given from the terminal device, comprises a communication module receiving request information from a terminal device on a network, and transmitting display information for specifying a display content on the terminal device, and an embedding module embedding information display functions for displaying information provided on the network or service gateway functions to services provided on the network, into the display content.

The display information is, e.g., a Web page. Further, the information display functions are display objects such as a telop for displaying a news headline in real time, an icon for informing of a weather forecast, an image and text for displaying a stock price and an exchange rate in graphs and numerical values in real time, and others. The present server embeds the information display function and the service gateway function into the Web page without any intermediary of the Web page provider.

The service gateway function in the customizing area is, for an example, a user interface (translation indicating module) displayed on the terminal device and used for an information browsing user to input executing a translation into a predetermined translation language. This translation indicating module may be defined as, e.g., a button on the screen, a hyperlink displayed in a character string, a hyperlink displayed as an image, and so on. This translation indicating module is embedded, whereby it is possible to detect an indication of the browsing user desiring to translate the display content into the predetermined translation language.

Preferably, the embedding module may embed definition information for defining the customizing area into the display information, and the communication module may transmit the display information embedded with the customizing area to the terminal.

Preferably, the server may further comprise a contract condition management module managing a contract condition with a provider of the information, and the embedding module may embed the customizing area into the information given from the provider establishing a contract under a predetermined contract condition. The Internet service can be provided in conformity with a request of the contractor, a property of the Web page etc by judging the contract condition described above. Further, the server is capable of enhancing the usability by diversifying the services depending on the contract conditions.

According to another aspect of the present invention, a relay device comprises a communication module relaying display information, transmitted from a server to a terminal device in response to request information given to the server from the terminal device, for specifying a display content on the terminal device, and an embedding module embedding a customizing area containing information display functions for displaying information provided on a network or service gateway functions to services provided on the network, into the display content. Thus, the customizing area can be embedded by the relay device that relays the server and the terminal device.

According to a further aspect of the present invention, an information providing method, actualized by a computer, of providing information, comprises receiving request information from a terminal device, and transmitting display information for specifying a display content on the terminal device in response to the request information, wherein the transmitting the display information involves embedding information display functions for displaying information provided on a network or service gateway functions to services provided on the network, into the display content.

According to a still further aspect of the present invention, there is provided a program executed by a computer to actualize any one of the functions (as the server, the relay device and the information providing method) described above.

According to a yet further aspect of the present invention, there is provided a storage medium readable by a machine, tangible embodying the program of instructions executable by the machine.

As explained above, according to the present invention, when the user (information provider) of the network transmits the information through the Web page etc, the usability of the user's own Web page can be enhanced by embedding the services (functions) on the network into the user's own Web page. Moreover, what can be prospective is that the user's own Web page is browsed by a much larger number of network service users. Further, the network service provider can gain a further increase in the number of members.

### BRIEF DESCRIPTION OF THE DRAWINGS

FIG. 1 is a diagram showing a principle of embedding buttons into a Web page in one embodiment of the present invention;

FIG. 2 is a diagram showing an outline of a translation button embedding process into the Web page;

FIG. 3 is a diagram showing a system architecture of the present information system;

FIG. 4 is diagram showing a display example of a normal Web page;

FIG. 5 is a diagram showing an example of the Web page into which the translation buttons are embedded;

FIG. 6 is a diagram showing an example in which a Japanese page is translated into an English version by clicking the translation button;

FIG. 7 is a diagram showing a data flow when translating;

FIG. 8 is a diagram showing an example of an HTML source for displaying the Web page before embedding the translation buttons;

FIG. 9 shows an example of the HTML source of the Web page after embedding the translation buttons;

FIG. 10 is a diagram showing an example of a member database of an ISP 10;

FIG. 11 is a flowchart showing a contract member oriented translation button embedding process;

FIG. 12 is a flowchart showing a Web page translation process in a translation server 4;

FIG. 13 is a diagram showing a display example where the translation buttons are displayed in a button window 30;

FIG. 14 is a diagram showing an example of the HTML source for displaying the button window 30;

FIG. 15 is diagram showing an example of the HTML source for displaying the button window 30;

FIG. 16 is a diagram showing a system architecture of the information system in a second embodiment;

FIG. 17 is a diagram showing a data structure of a redirect address table;

FIG. 18 is a diagram showing a data structure of a service contract management table;

FIG. 19 is a diagram showing examples of screen layouts;

FIG. 20 is a diagram showing an example of the function-embedded Web page;

FIG. 21 is a diagram showing an example of the HTML source describing the function-embedded Web page;

FIG. 22 is a flowchart showing a process of obtaining the information from and embedding the functions into an original Web page; and

FIG. 23 is a diagram showing details of a default page generation process (S21 in FIG. 22).

### DETAILED DESCRIPTION OF THE PREFERRED EMBODIMENTS

Preferred embodiments of the present invention will hereinafter be described with reference to the accompanying drawings.

<<First Embodiment>>

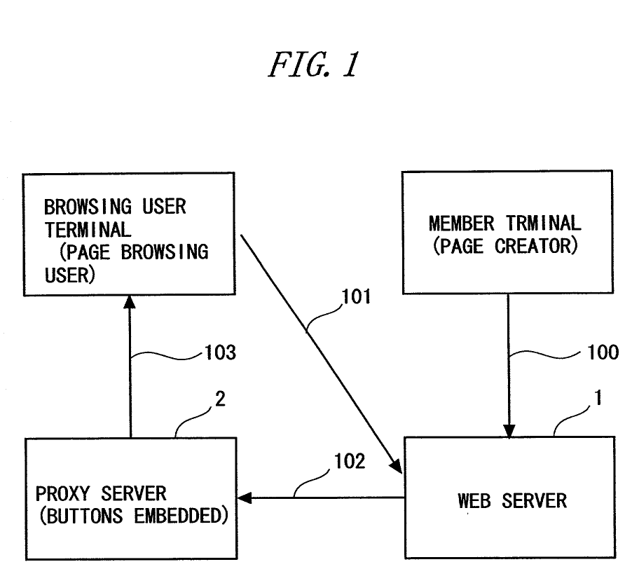

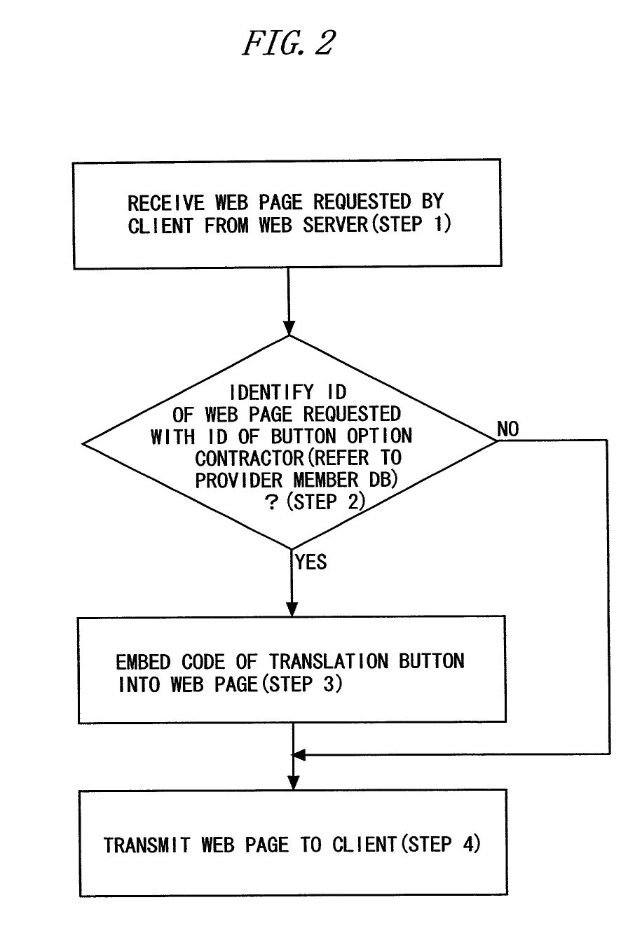

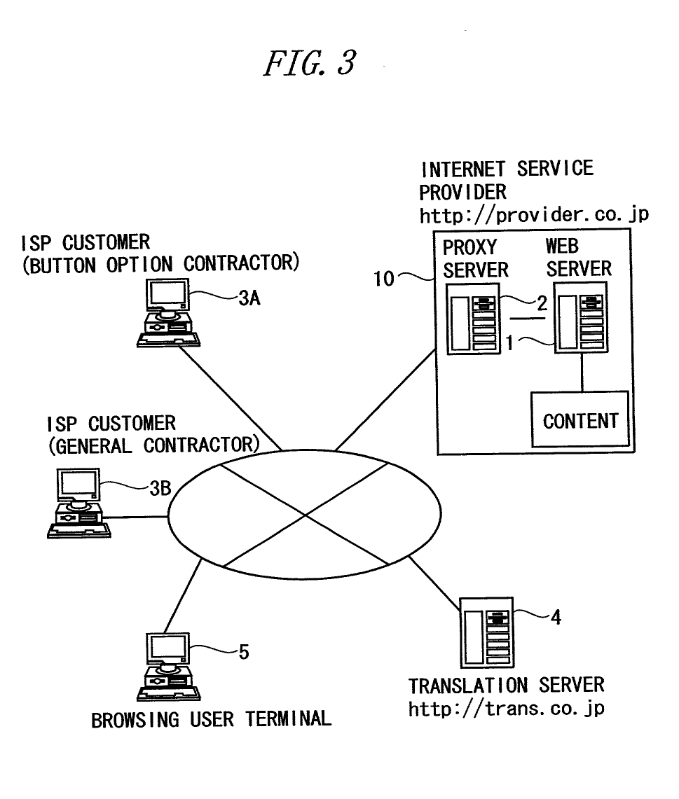

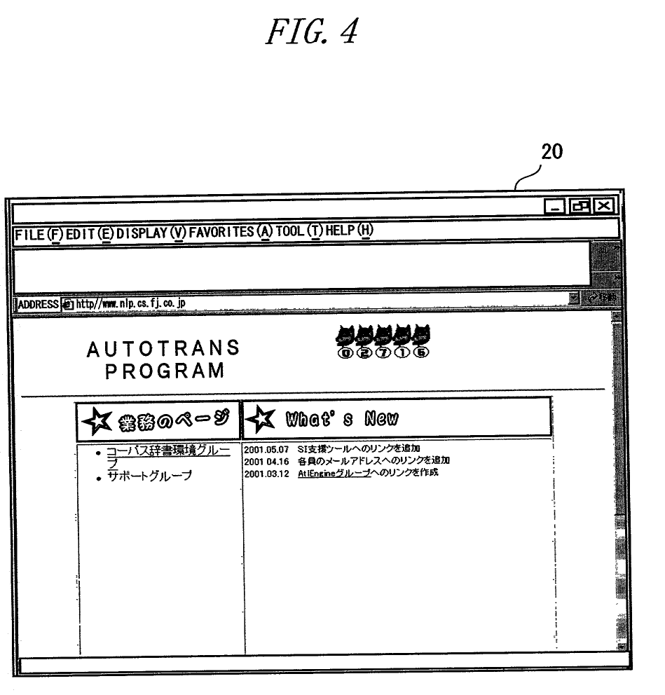

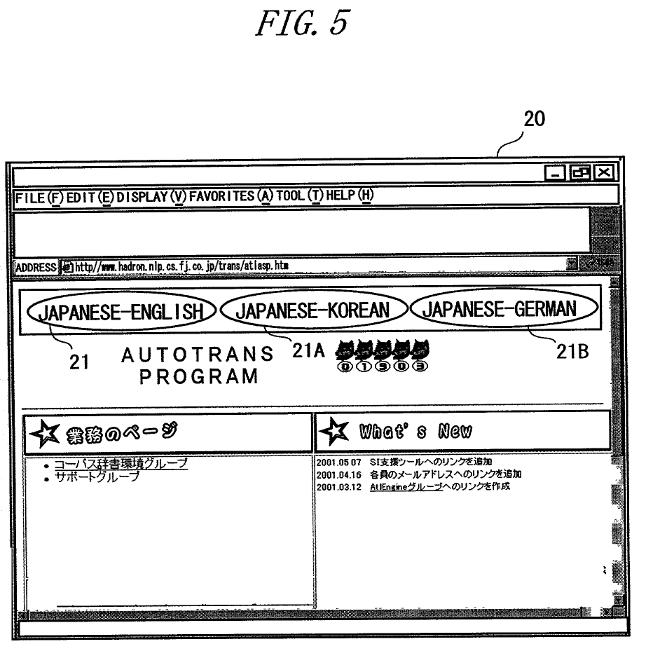

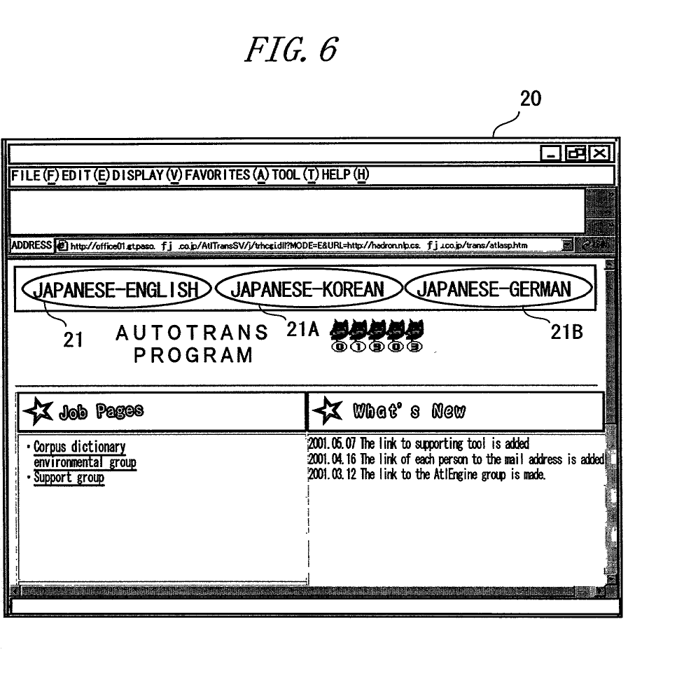

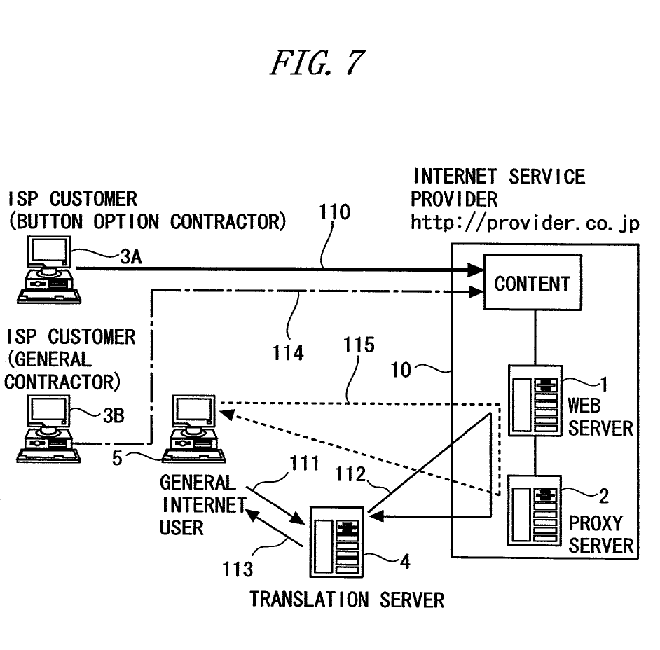

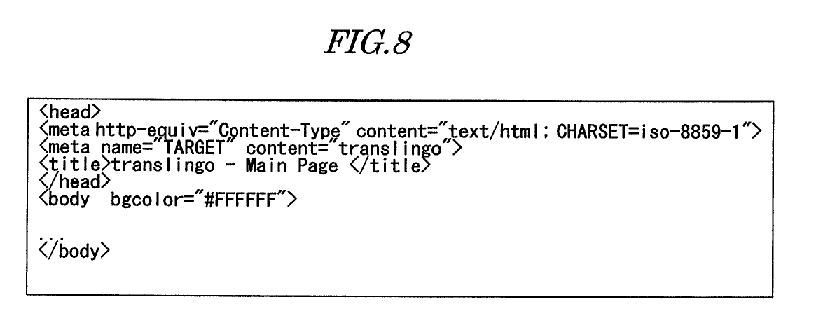

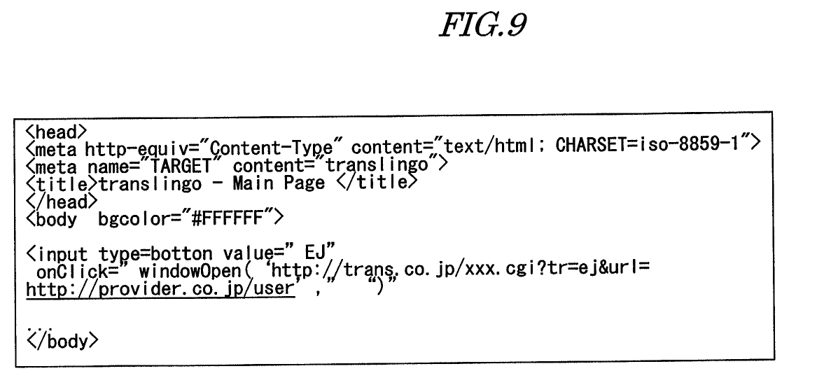

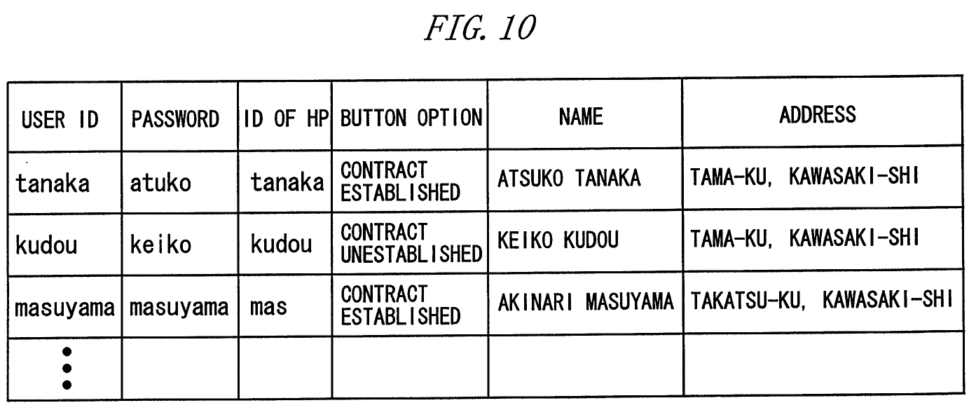

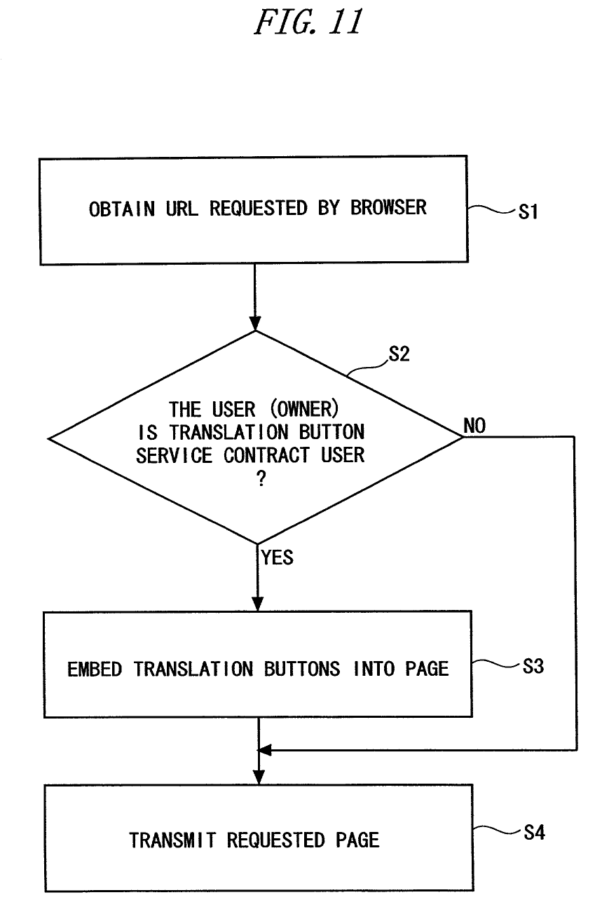

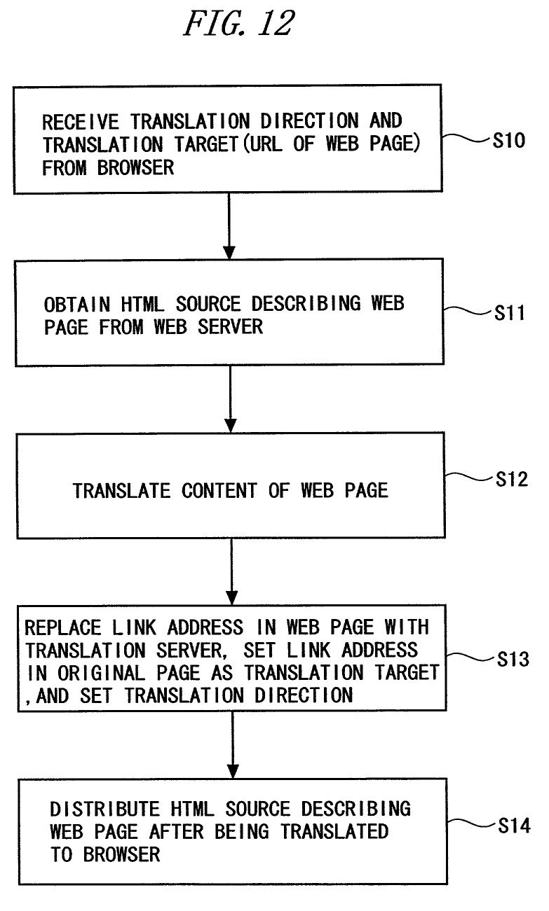

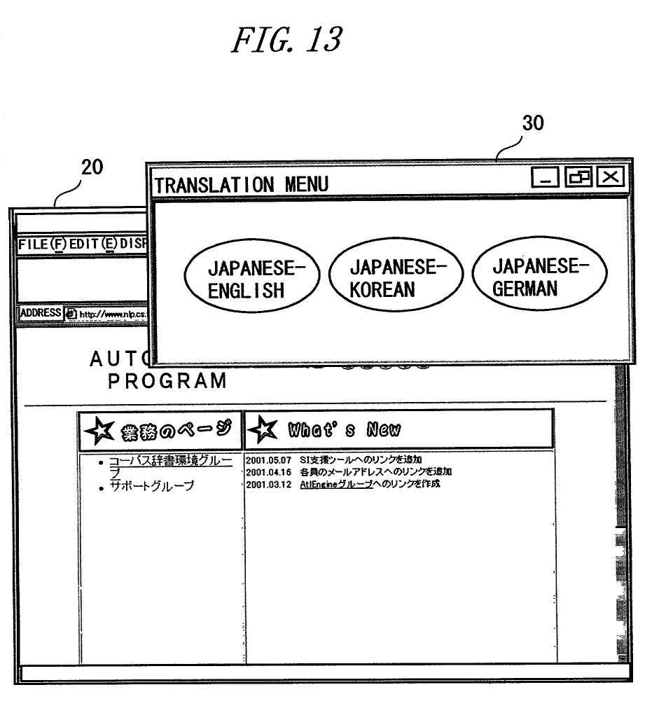

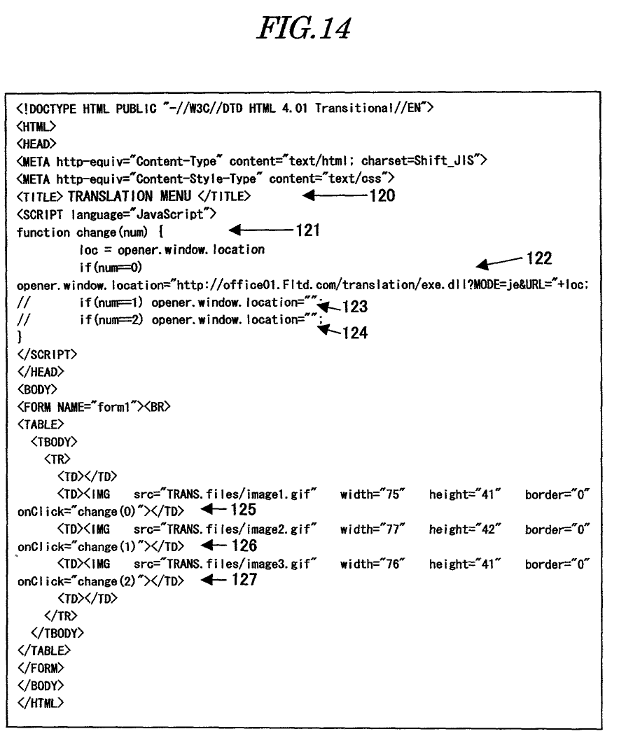

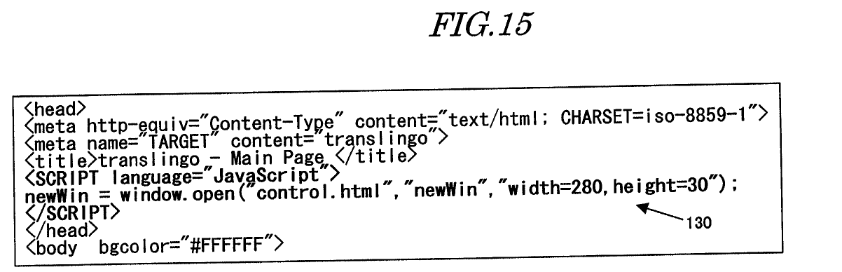

An information system in a first embodiment of the present invention will hereinafter be discussed with reference to drawings of FIGS. 1 through 15. FIG. 1 is a diagram showing a principle of embedding buttons into a Web page in the present information system. FIG. 2 is a diagram showing an outline of a translation button embedding process into the Web page. FIG. 3 is a diagram showing a system architecture of the present information system. FIG. 4 shows an example of displaying a normal Web page. FIG. 5 shows an example of the Web page into which the translation buttons have been embedded. FIG. 6 illustrates an example in which a Japanese page is translated into an English version by clicking the translation button. FIG. 7 is a diagram showing a data flow when translating in this information system. FIG. 8 shows an example of an HTML (HyperText Markup Language) source of the Web page before embedding the translation buttons. FIG. 9 shows an example of the HTML source of the Web page after embedding the translation buttons. FIG. 10 illustrates an example of a member database of an ISP 10 shown in FIG. 7. FIG. 11 is a flowchart showing a contract member oriented translation button embedding process. FIG. 12 is a flowchart showing a Web page translation process in a translation server 4 illustrated in FIG. 7. FIG. 13 shows a display example where the translation buttons are displayed in a separate window (a button window 30) in a modified example of the present information system. FIG. 14 shows an example of JavaScript describing the button window 30 shown in FIG. 12. FIG. 15 shows an example of the HTML source that displays the button window 30.

<Principle of Information System>

FIG. 1 shows the principle of the present information system. This information system is basically configured by a Web server 1 for distributing Web pages, a proxy server 2 for relaying the Web page distributed, a member terminal that provides the Web server 1 with information (HTML source) describing the Web page, and a browsing terminal that displays the Web page distributed from the Web server 1. The Web server 1 and the proxy server 2 among those machines are administered by an Internet Service Provider (that will hereinafter be abbreviated to ISP 10).

In this information system, the Web server 1 distributes the information as a Web page which has been uploaded (indicated by an arrowhead 100) from the member terminal to the browsing terminal. This information system, however, embeds the button for accepting a translation request from the user who browses the Web page, into this Web page of the member having established a special contract with the ISP 10. This button embedding process will be outlined.

A Browser for communicating with the Web server 1 runs on the browsing terminal. The Browser detects a user's event and transmits (as indicted by an arrowhead 110) to the Web server 1 a request for distributing a Web page to which a URL (Uniform Resource Locator) specified is hyperlinked based on HTTP (HyperText Transfer Protocol). This distribution request is sent via the proxy server 2 to the Web server 1.

Responding to the distribution request, the Web server 1 distributes the information (HTML source) describing the requested Web page to the Browser via the proxy server 2 (as indicated by an arrowhead 102).

At this time, the proxy server 2 judges whether the information (HTML source describing the Web page) distributed from the Web server 1 to the Browser on the browsing terminal, is given from a contractor (who will hereinafter be called a button option contractor) having made the special contract described above. Then, if the requested Web page is sent from the button option contractor, the proxy server 2 embeds button information used for the browsing user to make a request for the translation, into the HTML source describing that Web page, and transfers this button-embedded HTML source to the browsing terminal (as indicated by an arrowhead 103).

Then, the Browser on the browsing terminal embeds the buttons into the original Web page created by the member, and thus displays the Web page on a screen of the browsing terminal. The browsing user makes the request for translating the Web page as the necessity may arise by using (clicking) these buttons. As a result, text information on the Web page is translated into a predetermined language, and the translated text information is displayed on the browsing terminal.

FIG. 2 shows the outline of the button embedding process in the proxy server 2. In this button embedding process, at first, the proxy server 2 receives the HTML source describing the Web page distributed to the terminal from the Web server 1 (step 1).

Next, the proxy server 2 judges whether a piece of identifying information ID of the Web page distributed is owned by the button option contractor (step 2). Herein, the button option contractor is defined as a contractor who has established with the ISP 10 a contract for embedding the translation request button described above into the Web page distributed.

Then, if judging that this Web page ID is owned by the predetermined button option contractor, the proxy server 2 embeds a code describing the translation request button into the HTML source that describes the very Web page (step 3). Subsequently, the proxy server 2 transmits, to the browsing terminal, the HTML source embedded with the code describing the button (step 4).

Whereas if judging that the Web page ID is not owned by the predetermined button option contractor, the proxy server 2 transmits the Web page as it is to the browsing terminal (step 4).

<System Architecture>

FIG. 3 shows the system architecture of this information system. As shown in FIG. 3, this information system is configured by the ISP 10 constructed of the Web server 1 and the proxy server 2, ISP customer terminals 3A, 3B each establishing a contract with the ISP 10 and transmitting their own Web pages via the Web server 1, a browsing user terminal 5 receiving the distribution of contents such as the Web pages and so on from the Web server 1, and a translation server 4 that executes translation programs, which are all connected to each other via a network such as the Internet etc.

The Web server 1 provides a function of distributing the Web page based on HTTP. Namely, the Web server 1 accepts the Web page distribution request from the browsing user terminal 5, and distributes a content that meets the request. Note that a category of the browsing user includes the ISP customers and general Internet users.

The proxy server 2 connects a network inside the ISP 10 to the Internet. Namely, the proxy server 2 transmits, for example, the request from the terminal 5 to the Web server 1. Further, the proxy server 2 transmits the information distributed from the Web server 1 to the Internet. The Web server 1 and the proxy server 2 may be classified as general computers each including a CPU, a memory, a hard disk, a communication board (communication modules) and others.

The ISP customer terminal 3A or 3B uploads the HTML source describing the Web page into the Web server 1, and the Web server 1 distributes this Web page to the browsing user terminal 5.

The ISP customer may be categorized as a customer who has established a contract for receiving an access service from an Internet service provider such as the ISP 10. As shown in FIG. 3, the ISP customers are further categorized into the button option contractor and a general contractor. The button option contractor is the customer establishing with the ISP 10 a contract of service for embedding the translation buttons into the Web page described above. Further, the general contractor is a customer who has not established such a service contract.

The browsing user terminal 5 requests the ISP 10 to provide a content, and displays the distributed content on the screen thereof. The terminals 3A, 3B or the terminals 5 are, e.g., personal computers, mobile telephones, PHSs (Personal Handyphone Systems), PDAs (Personal Digital Assistants) and others, and include unillustrated CPUs, memories, communication interfaces, pointing devices and so on.

The translation server 4 translates the content distributed to the ISP customer terminal 3. The translation server 4 is also a general computer as in the case of the Web server 1 and the proxy server 2. Referring again to FIG. 3, the translation server 4 is provided independently of the ISP and connected to the Internet, and provides its service on the Internet. The translation server 4 may, however, serve as a dedicated system within the ISP 10 and may communicate with the terminal 5 and others via the proxy server 2. Further, the translation server 4 may also be a server administered by an organization (corporation) and an individual independent of the ISP 10.

Moreover, the translation server 4 may not be singular as in the first embodiment, but there may be taken an architecture of providing a plurality of translation servers. For instance, the plurality of translation servers are prepared corresponding to the respective versions (languages) of the translations, and the translation server for a translation requester maybe defined corresponding to the button to be embedded.

Further, the present invention may be actualized by a single system implementing the respective functions of the Web server, the proxy server and the translation server (for providing the button embedding service), which are required for embodying the present invention. (Example of Screen>

FIGS. 4 through 6 each show a configuration of the screen displayed on the browsing user terminal 5 in the present information system. FIG. 4 depicts a display example of a normal Web page based on the content created by the member.

Referring to FIG. 4, a Web page containing titles (Gyoumu no Peiji in Japanese (Job Pages in English)] and [What's New] is displayed in a display area of a Browser 20. Further, hyperlinks (each defined as a character string for specifying a different Web page, wherein the specified Web page is displayed by clicking this character string with a mouse etc) such as [Kopasu Jisho Kankyou Gurupu in Japanese (Corpus Dictionary Environment Group in English) and [Sapouto Gurupu in Japanese (Support Group in English)], are displayed under the title [Job Pages].

FIG. 5 illustrates a display example of a Web page, of which the HTML source uploaded from the button option contractor has been subjected to the processing according to the present invention, distributed to the browsing user terminal 5. Referring to FIG. 5, the Browser 20 similarly displays the same Web page as that illustrated in FIG. 4. In FIG. 5, however, a translation button 21 labeled with [Japanese-English], a translation button 2A labeled with [Japanese-Korean] and a translation button 2B labeled with [Japanese-German], are displayed in an upper area on the screen (the information system in the first embodiment displays the translation buttons corresponding to all the translation directions (versions ) of the languages that can be translated by the translation server 4). The browsing user clicks this button 21, whereby the content (text) of the Web page can be translated into a predetermined language.

For example, when the browsing user clicks the translation button 21 or 21A or 21B, the content on the screen is translated from Japanese into English, or from Japanese into the Hankul alphabet, or from Japanese into German.

FIG. 6 shows an example where the browsing user clicks the translation button 21 and the Japanese page is translated into English. As described above, upon clicking the translation button 21, the content displayed on the Browser 20 is translated into English. For instance, referring to FIG. 5, the title displayed as [Gyoumu no Peiji in Japanese (Job Pages in English)] is translated into “Job Pages”. Further, the hyperlink character strings [Kopasu Jisho Kankyou Gurupu in Japanese (Corpus Dictionary Environment Group in English) and [Sapouto Gurupu in Japanese (Support Group in English)] are translated into “Corpus Dictionary Environment Group” and “Support Group”.

Note that the embodiment of the present invention is not limited to the above Web page display mode of displaying only on English (and other translated languages) as a result of the translation. There may be taken, e.g., a side-by-side display mode in which English as a result of the translation is displayed side by side with Japanese (as the original language). Further, the result of the translation may be displayed in a Browser different from the Browser in which the Web page in the original language is displayed. According to a multi-window system, the translated result and the original language may be displayed in the windows separate from each other.

<Data Flow in Translation>

FIG. 7 shows a data flow in translation. As described above, the contractors of the ISP 10 are categorized into the button option contractor and the general contractor. The button option contractor operates the terminal 3A to upload the HTML source describing the Web page (as indicated by an arrowhead 110). On the other hand, the general contractor operates the terminal 3B to upload the HTML source describing the Web page (as indicated by an arrowhead 114). The HTML source may be uploaded based on a generally known protocol, i.e., FTP (File Transfer Protocol).

When uploading the HTML source, a contractor's identity is authenticated, and the uploaded HTML source is managed according to a contractor's ID. The proxy server 2, when relaying the distribution of the Web page supplied from the Web server 1, judges whether the distributed Web page is a Web page of the button option contractor or the general contractor. Then, the predetermined translation buttons are embedded into the Web page of the button option contractor (if judged so). In this case, the proxy server 2 in the first embodiment displays the translation buttons corresponding to all the translation languages that can be translated.

Note that the request for distributing the Web page is issued to the Web server 1 from the terminal 5 (Browser) of the general Internet user, and the Web page specified or created based on this request is transmitted via the proxy server 2 to the terminal 5 (Browser) from the Web server 1 in this example (as indicated by an arrowhead 115).

It is now assumed that the translation buttons 21 be, as shown in FIG. 5, displayed in the Web page on the browsing user terminal 5.

When the browsing user clicks the translation button 21 with the unillustrated pointing device, the Browser 20 detects this event. Then, the Browser 20 specifies a translation target (which is a display target to which the URL (Uniform Resource Locator) is hyperlinked) and which translation direction has been selected. Further, the Browser 20 obtains a link address (the translation server 4: http://trans.co.jp) of the button. Then, the Browser 20 transmits the translation version and the translation target to the translation server 4 (as indicated by an arrowhead 111).

The translation server 4 specifies the translation target and the translation version from parameters received. Next, the translation server 4 acquires a content specified as the translation target from the Web server 1 (http://provider.co.jp) on the Internet (as indicated by an arrowhead 112), and translates the HTML source.

In this case, if the translated result contains a hyperlink, the translation server 4 replaces all the link addresses with URLs of the translation program of the translation server 4, and sets a parameter specifying the translation target, i.e., a URL as a source link address.

(Setting Example)

http://trans.co.jp/xxx.cgi?tr=je&url=htt://provider.co.jp/user

where http://trans.co.jp/xxx.cgi is the URL of the translation program of the translation server, and a code element after “?” is parameters transferred to the translation program. Further, “tr=je” is the translation version, and “url=http://provider.co.jp/user” is the URL as the source link address.

With this setting, when navigating along the hyperlinks from the Web page defined as the translated result, the translation process is executed for each link address. Then, the translation server 4 distributes the translated Web page to the terminal 5 of the browsing user (as indicated by an arrowhead 113).

Further, the translation buttons described above are not embedded into the Web page of the general contractor, and hence the translation explained above is not carried out.

<Data Structure>

FIG. 8 shows the example of the HTML source describing the Web page before the translation buttons 21 are embedded. FIG. 9 shows the example of the HTML source describing the Web page into which the translation buttons 21 have been embedded.

As shown in FIG. 9, in a set of tags <body>and </body>, a button is defined (input type=button), a translation program is specified by http://trans.co.jp/xxx.cgi defined as a link address, and a translation direction “je” (Japanese-English) and a translation target http://provider.co.jp/user are specified as the parameters transferred to this specified translation program.

Accordingly, when clicking the button displayed on the Browser 20 in accordance with this definition, the translation direction and the translation target are transmitted to the translation program of the link address.

FIG. 10 shows the example of a data structure of the member database of the ISP 10, which is retained by the proxy server. Each of lines in the table shown in FIG. 10 is defined as one record of the database. As shown in FIG. 10, each record of the member database includes pieces of data entered in a “user ID” field, a “password” field, a “Web page ID” field (“ID of HP” field in FIG. 10), a “button option” field, a “name” field and an “address” field.

The user ID is a symbol for identifying each member. The password is a character string exclusively known by the member and used for authenticating the member's identity. Namely, when the password registered in the member database is inputted together with the user ID on a member authentication screen, the member's identity is authenticated.

The ID of HP is a piece of information for specifying an area into which each member uploads the HTML source describing the Web page. Each member, when authenticated by the user ID and the password in the ISP 10, is allowed to upload the HTML source. The thus uploaded HTML source is stored in the area specified by the ID of HP. Further, the URL of this Web page is normally defined such as ISP URL/HP ID. For instance, when the ISP URL is http://provider.co.jp/, the URL of the HTML source identified by the HP ID “tanaka” in FIG. 10 becomes http://provider.co.jp/tanaka.

The “button option” field is recorded with a contract established or unestablished by each member for embedding the translation buttons into the Web page. For example, in the record of the member identified by the user ID “tanaka”, a piece of information [contract established] is entered in the “button option” field. When the Web page of this member is browsed, the translation buttons 21 (all of which correspond to the languages supported by the translation server 4) specifying the translation directions as shown in FIG. 5, are embedded into this Web page. Then, when the browsing user clicks one of the translation buttons, the information on the Web page is translated into a language specified by the clicked button, and the translated information is displayed. A name and an address of each member are entered in the “name” and “address” fields.

<Operation>

FIG. 11 is the flowchart showing the specified member oriented translation button embedding process. In this information system, this button embedding process is executed by the proxy server 2.

In this process, to start with, the proxy server 2 obtains from the Web server 1 a URL locating the Web page receiving a browsing request from the requesting side, i.e., from the Browser 20 as well as obtaining this Web page (S1). This URL obtained is, e.g., http://provider.co.jp/user.

Further, an address of the Browser 20 (terminal 5) having issued the browsing request is obtained likewise from the Web server 1.

Next, the proxy server 2 reads the Web page ID attached to the tail of the URL hyperlinked to the Web page having the browsing request. Then, the proxy server 2 searches the member database with this ID used as a key, and checks based on the information entered in the “button option” filed whether the member (user) specified by the Web page ID has established the contract for the translation button embedding service (S2).

If this member has established the contract for the translation button embedding service, the proxy server 2 embeds the translation buttons into the Web page (S3). Then, the proxy server 2 transmits this Web page to the Browser 20 (S4).

Whereas if this member has not established the contract for the translation button embedding service, the proxy server 2 directly transmits this Web page to the Browser 20 (S4).

FIG. 12 is the flowchart showing steps of a Web page translation process. This translation process is executed by the translation server 4. In this process, at first, the translation server 4 obtains the translation direction and the translation target (specified by the URL of the Web page) from the Browser 20 (S10).

Next, the translation server 4 obtains the HTML source describing the Web page from the Web server 1 (S11). Then, the translation server 4 translates a content of the Web page (S12).

Subsequently, the translation server 4 sets all the link addresses within the Web page into the translation program of the translation server 4. Further, the translation target (specified by the URL in the original page) and the translation direction are set as parameters transferred to the translation server 4 (S13).

Next, the translation server 4 transmits to the Browser 20 the HTML source describing the Web page after being translated (S14).

<Effects of Embodiment>

As discussed above, the user who discloses the Web page by utilizing the present information system is able to transmit the information worldwide simply by creating the content in the user's native language (Japanese in the first embodiment). Note that the Web page before being translated is assumed to be what is created in Japanese in the first embodiment, however, the embodiment of the present invention is not limited to the Web page created in Japanese. As described above, the Web page is translated into the language desired by the browsing user upon the operation (event) by the browsing user, and therefore a barrier caused by a difference between the languages can be reduced.

Moreover, according to the present information system, when the translation server 4, when translating the Web page, sets the link addresses contained in this Web page into the translation program of this translation server 4, and, when further hyperlinked therefrom, sets the translation target (the link address in the original page) and the translation direction as parameters transferred to the translation server 4. Hence, the browsing user can set so that the translation server 4 translates also a destination (Web page) hyperlinked from the translated Web page.

Further, the ISP 10 in the present information system can acquire new members who wish to transmit their own homepages overseas by providing the translation button embedding service. Moreover, it is possible to gain an income from advertisement browsed by the browsing users in a wide range also in the case of providing a banner advertisement to the translation page.

<Modified Example Using Different Window>

In the information system described above, the translation buttons 21 are embedded into the Web page as shown in FIG. 6, and the content of the Web page is translated into the predetermined language by the browsing user's event. The embodiment of the present invention is not, however, confined to such a configuration of the screen. For example, the translation buttons may be displayed in a button window different from the Browser 20, and the browsing user may select the translation language.

FIG. 13 illustrates an example where the translation buttons are displayed in the different window. In this example, when the browsing user browses the Web page on the Internet through the Browser 20, a button window 30 titled [translation menu] is displayed to prompt the browsing user to select a translation language by use of one of the buttons.

When the browsing user clicks, e.g., the button labeled with [Japanese-English] by use of the pointing device, as in the embodiment discussed above, the translation direction and the translation target (Web page) are transmitted to the translation server 4, and the translation server 4 translates the texts, the character strings of the hyperlinks and others within the Web page.

FIG. 14 shows the example of JavaScript describing the button window 30 illustrated in FIG. 13. According to JavaScript, within a set of tags <HEAD> and </HEAD>, for example, the title [translation menu] is defined (line 120), and a procedure of the Web page translation request given to the translation server 4 is defined in a function “change” (line 121).

Further, within the tags <BODY> and </BODY>, three buttons are defined (lines 125 through 127) with reference to an image file. Herein, when clicking the button defined in, e.g., the line 125, the function “change” in which an argument “0” is set, is started.

In the function “change”, when “0” is given to the argument “num”, the translation direction (“je” which means an indication of translating, e.g., Japanese into English) and the translation target (“+loc” specifying the present page) (line 122) are transferred to a program specified by http://office.Fltd.com/translation/exe.dll of the translation server 4.

Further, when describing hyperlinks in the lines 123 and 124 together with the translation directions such as “Japanese-Korean”, “Japanese-German” and “Japanese-Chinese”, it is possible to meet requests for such versions.

Note that JavaScript, which opens the button window 30 when the translation server 4 creates the HTML source as a result of the translation, is commented out to prevent the button window 30 from being displayed when displaying the translated result, and, instead, Script for closing the opened button window 30 may be installed. When the translation server 4 transmits such a translated result to the Browser 20, the button window 30 is displayed on the browsing user terminal 3 only when necessary (when the first requested page is displayed).

FIG. 15 shows the example of the HTML source that opens the button window 30 defined as shown in FIG. 14. In this HTML source, “control.html” (corresponding to JavaScript in FIG. 14) is started in a line 130 within a set of tags <head> and </head>. When the Browser 20 on the browsing user terminal accesses the Web page described by the HTML source shown in FIG. 15, the above script is executed, whereby the button window 30 shown in FIG. 13 opens on the screen.

<Modified Example of System Architecture>

According to the information system in the first embodiment discussed above, when the proxy server 2 relays the Web page distributed from the Web server 1, the translation buttons 21 are embedded into the Web page. The embodiment of the present invention is not, however, limited to the architecture and procedures described above. For example, not the proxy server 2 but the Web server 1 itself may embed the translation buttons 21 into the Web page. In this case, the program running for executing the process shown in FIG. 11 may be executed by the Web server 1.

Further, in the first embodiment discussed above, the proxy server 2 relays both of the request given to the Web server 1 from the browsing user terminal 5 etc and the response (implying the distribution of the Web page) from the Web server 1 in response to this request. The request given to the Web server 1 from the browsing user terminal 5 etc may be relayed by other device, and the proxy server 2 may relay the response given from the Web server 1. Namely, the proxy servers different from each other may relay the request and the response, respectively.

<Modified Example of Interface with Translation Server 4>

The first embodiment has involved the use of CGI (Common Gateway Interface) for transferring the translation direction and the translation target to the translation server 4. Further, in the modified example described above, the parameters such as the translation direction and the translation target are transferred to the translation server 4 by executing JavaScript. The interface for transferring the translation direction and the translation target to the translation server 4 is, however, limited to neither CGI nor JavaScript.

For example, the parameters such as the translation direction and the translation target may be transferred to the translation server 4 by using PHP Script provided by PHP Group (http://www.php.net). PHP Script is described in a <?PHP> tag set in the HTML source describing the Web page. Further, a content in the <?PHP> tag set is interpreted by the Web server supporting PHP, and, as a result, PHP Interpreter is started, thereby executing Script described therein.

Further, the parameters such as the translation direction and the translation target maybe transferred to the translation server 4 by use of, e.g., ASP (Active Server Pages) provided by Microsoft Corp., U.S.A. According to ASP, Script (such as VBSript, Jscript etc) is described in the HTML source describing the Web page. An extension “asp” is suffixed to the HTML source file containing Script described above. The Web server supporting ASP executes internally-defined Script and others with respect to the HTML source suffixed with the extension “asp”.

Moreover, the same function as ASP is provided as JSP (Java Server Pages) by Java (that is a trademark of Sun Microsystems, Inc., U.S.A). The parameters such as the translation direction and the translation target maybe transferred to the translation server 4 by utilizing JSP. According to JSP also, the processes are described as Script in the HTML source describing the Web page. When the HTML source is requested from the Browser, the Web server supporting JSP executes Script and replaces Script with an executed result thereof, thus transferring it to the Browser.

<Variations in Number of Translation Buttons>

The translation server 4 in the embodiment discussed above displays the translation buttons corresponding to all the translation directions (Japanese-English, Japanese-Korean, Japanese-German, Japanese-Chinese, etc) supported by the system. Instead, however, the member may previously select the translation direction when establishing the contract, and the button may be embedded based on this contract. For attaining this, the contract showing which version is selected, may be registered in the member database (FIG. 10). The proxy server 2 or the Web server 1 refers to the member database and may embed into the Web page the button specifying the selected-by-the-member translation direction registered in the member database.

<Variations in Timing for Embedding Translation Button>

According to the embodiment discussed above, the proxy server 2 embeds the translation button when responding to the request from the Browser 20. The present invention is not, however, confined to this procedure.

For example, when a content creator uploads the content to the Web server 1 to execute a transfer based on FTP (File Transfer Protocol), the program executed by the Web server 1 may embed the translation button into the HTML source. In this case, the proxy server 2 explained above is not required.

Further, if an updated content is detected by periodically monitoring the Web server 1, the translation button may be embedded into the uploaded content. As for the update of the content, this update may be detected by looking at a timestamp in the file. In this case, the detection of updated content involves providing a database for recording a timestamp for every ID (ID of HP in FIG. 10) of the content of the member. Alternatively, the member database shown in FIG. 10 may also be recorded with the latest timestamp corresponding to each content.

<Variations in Procedure of Determining Translation Button Corresponding to Language of Web Page>

The assumption in the first embodiment discussed above is that the members of the ISP 10 are Japanese and that the Web page before being translated is described in Japanese. The language describing the Web page may be judged based on the character code describing the page, and the translation direction may be determined based on this language. Namely, the translation button embedded into the HTML source may be determined based on the language describing the Web page before being translated.

(Judging Method by HTML)

The language can be distinguished based on a value of a code element “Charset” in a tag <META> within a header field (defined by <HEAD> and </HEAD>) in the HTML source. For example, if any one of the following three descriptions is given as a value of “Charset”, it may be judged that the content is described in Japanese.

Value (Meaning)

ISO-2022-JP (ISO-2022-JP (RFC1468)

EUC-JP (Japanese EUC (Compression Format))

Shift_JIS (Shift JIS)

The followings are examples of the descriptions.

### EXAMPLE 1

<META HTTP-EQUIV=“Content-Type”

Content=“text/html;charset=Shift_JIS”>

### EXAMPLE 2

<META HTTP-EQUIV=“Content-Type”

Content=“text/html;charset=ISO-2022-JP”>

### EXAMPLE 3

<META HTTP-EQUIV=“Content-Type”

Content=“text/html;charset=EUC-JPf”>

Note that the following values are entered as values of “Charset” on pages other than Japanese. There are categories in the ISO Standards for specifying the character sets, and West European countries are, though not so many, not necessarily uniquely determined. It is therefore impossible to determine the language before being translated by judging the value of “Charset” with respect to the West, East and North European countries.

(iso-8859)

iso-8859-1 West European countries

iso-8859-2 East European countries

iso-8859-3 Esperanto etc

iso-8859-4 North European countries

iso-8859-5 Russian

iso-8859-6 Arabic

iso-8859-7 Greek

iso-8859-8 Hebrew

iso-8859-9 Turkey

iso-8859-10 North European languages

(iso-8850)

ISO-8850-1 West European countries

(Distinction by Character Code of Content)

The language may be judged by extracting all or some of the texts from the content (HTML source) and analyzing the character code contained therein. For instance, the codes such as EUC, Shift-JIS, JIS etc are used for Japanese. A coincidence count may be calculated by comparing a bit pattern of the text data in the HTML source with each code table before translation. If there is the code of which the coincidence count is equal to or larger than a predetermined rate, it may be judged that this set of text data are described by this code.

<Substitutive Technology for Button>

According to the first embodiment, the translation buttons 21 are embedded into the Web page and used for making the translation request to the translation server 4. The embodiment of the present invention is not, however, limited to this type of user interface. For example, an image and a text may be used for hyperlinking without being confined to the buttons. For instance, hyperlinks defined by a tag <IMG> and a set of tag <A>, </A> that are shown as below can be displayed as an image and a text on the Web page.

(Example of Image)

Tags used: a tag set <A>,</A> and a tag <IMG>

Content described: <A HREF=http://trans.co.jp/ . . . ><IMG

SRC=“image data file name”></A>, wherein URL described by HREF is the same as URL explained above, and specifies a translation program, a translation direction and a translation target page with respect to the translation request.

(Example of Text)

Tags used: a tag set <A>, </A>

Content described: <A HREF=http://trans.co.jp/ . . . “>”translation direction”/A>, wherein a “Japanese-English” version may be, for instance, given by way of a description example of “translation direction”.

<Variations in Accounting Method>

In the first embodiment discussed above, the member of the ISP 10 is prompted to select a translation button embedding service option or a non-service option when establishing the contract. Then, an added fee for an option function is charged uniformly on the members (the content creator of the Web pages) who utilizes the above service. The embodiment of the present invention is not, however, limited to this procedure. For example, the fee may be charged according to a rate-basis system corresponding to how many translation buttons are provided.

Namely, the provider member selects language by language which version the Web page previously created by the member himself or herself is translated into, and establishes the contract with the ISP 10. The member specifies two languages, e.g., English and Hankul alphabet as translated versions. ISP 10 records a member management database with the categories of the translated versions specified in the contract. In this case, a “translated version” field is newly provided in the member database shown in FIG. 10, and the categories of the translated versions specified in the contract may be entered per member in this field.

Then, the ISP 10, when receiving the request for the Web page created by the member from the Browser on the browsing user terminal, may judge the translated version by referring to the “translated version” field in the record about this member in the database. Subsequently, the ISP 10 may determine the translation directions from the translated versions entered therein and the language (original language) of the content of the Web page. For example, if the content of the Web page is described in Japanese, the translation directions are a Japanese-English version and a Japanese-Korean version.

After determining the translation directions, the translation buttons (hyperlink information) corresponding to these translation directions are embedded into the HTML source of the Web page, and the Web page with the buttons is distributed to the Browser 20. This procedures is the same as in the first embodiment discussed above.

Note that the language (original language) of the content of the Web page may be either auto-judged or registered in the member management database beforehand. The former case is capable of restraining an increase in the data size of the member management database. Further, the latter case is capable of eliminating the necessity of the process executed for judging the language and reducing a processing load upon the server.

<<Second Embodiment>>

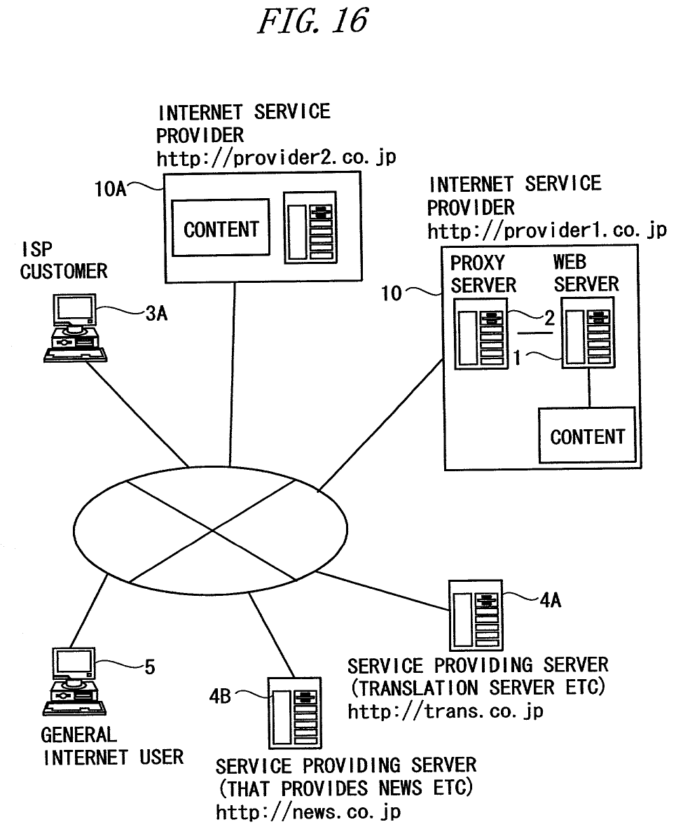

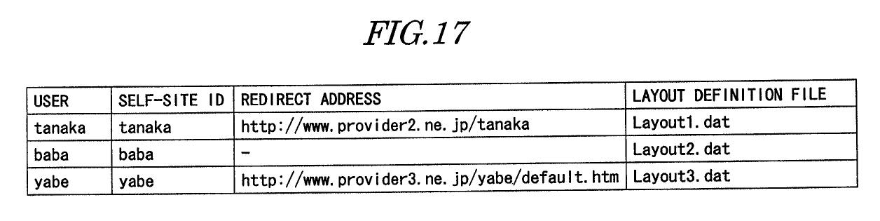

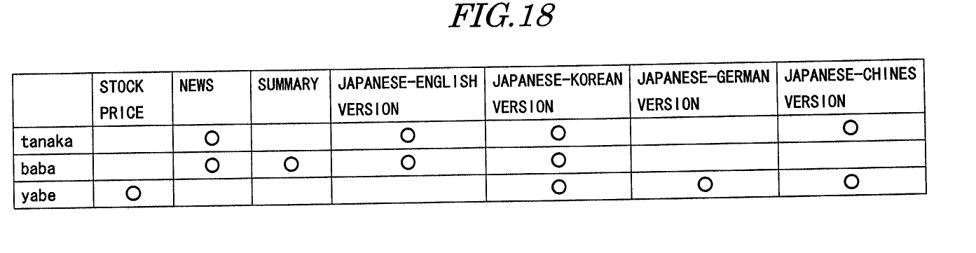

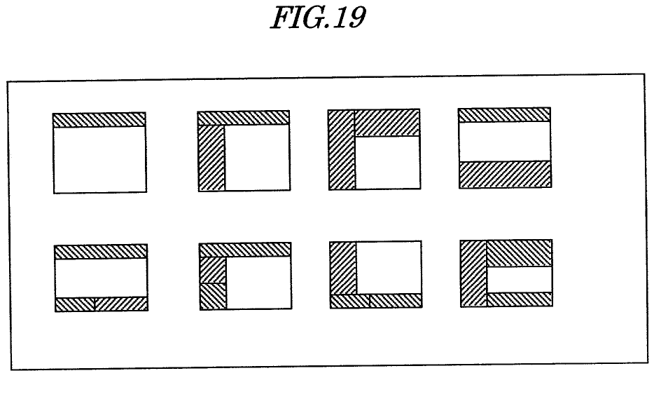

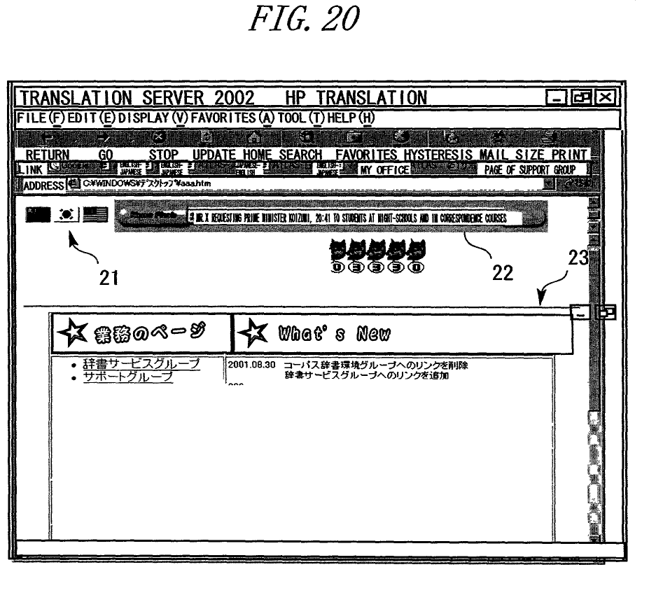

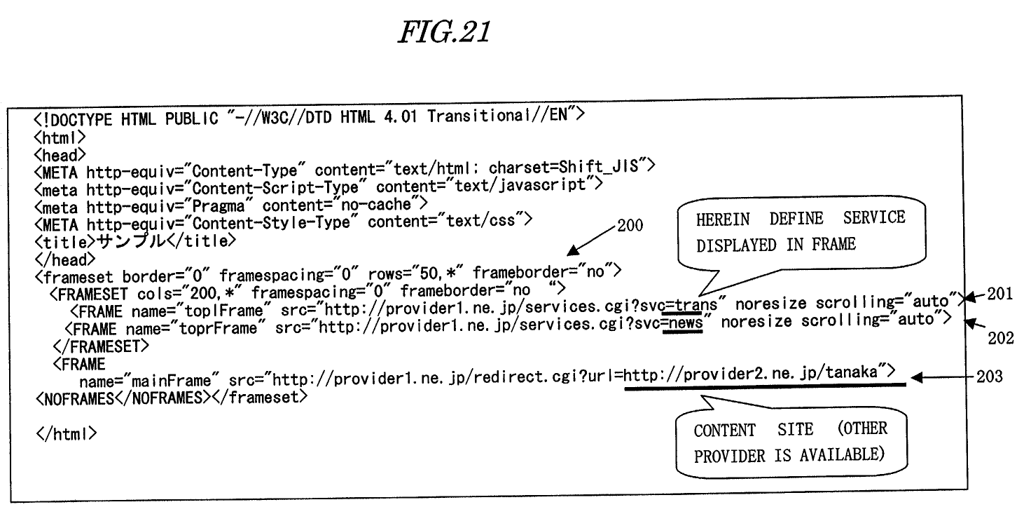

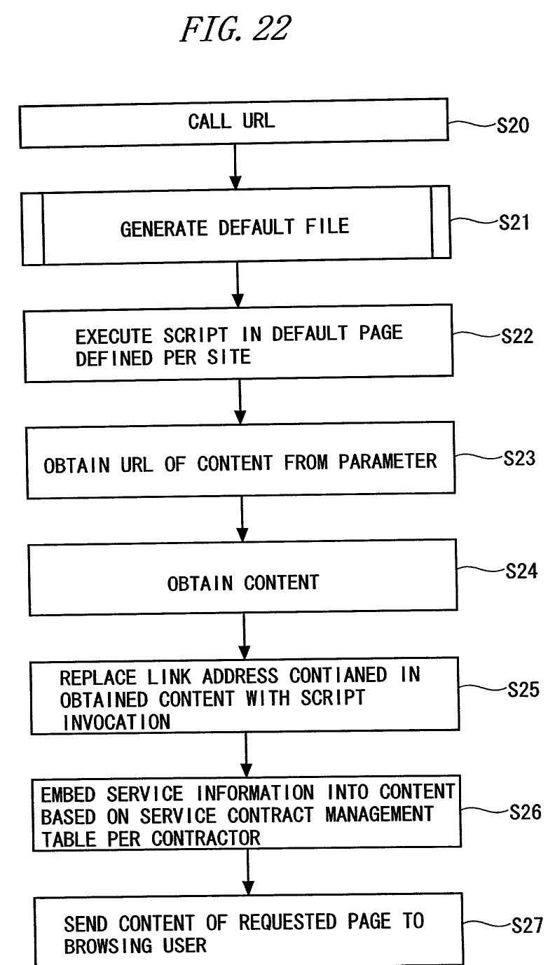

The information system in a second embodiment of the present invention will be explained with reference to the drawings of FIGS. 16 through 25. FIG. 16 is a diagram showing a system architecture of the information system in the second embodiment. FIGS. 17 and 18 are diagrams each showing a data structure of a table managed by the Web server 1 shown in FIG. 16. FIG. 19 is a diagram showing examples of layouts of the screen (screen split examples) when the Web server 1 shown in FIG. 16 embeds information display functions (interfaces) and service gateway functions (interfaces) into the Web page of the ISP customer. FIG. 20 shows an example of the screen of the function-embedded Web page into which the Web server 1 illustrated in FIG. 16 has embedded the translation buttons 21 and a news telop 22. FIG. 21 shows an example of the HTML source corresponding to the function-embedded Web page. FIG. 22 is a flowchart showing a process for the Web server 1 shown in FIG. 16 to embed the information display function or the service gateway function into the Web page.

The discussion in the first embodiment discussed above has been focused on the system in which the Internet service provider (ISP) 10 distributes the information uploaded as the Web page from the member's terminal to the browsing user terminal. Then, according to the first embodiment, the buttons and hyperlinks for accepting the translation request of the browsing user (member) of the Web page are embedded into the Web page of the member having established the special contract with the ISP 10.

The discussion in the second embodiment will be focused on the system for embedding the display function for displaying information to the browsing user, and the buttons, hyperlinks etc used to make requests for providing various services including the translation. Note that an interface (software component) used for requesting those services on the Web page is termed the “service gateway function”. Other configurations and operations are the same as those in the first embodiment. The same components are therefore marked with the same symbols, and their repetitive explanations are omitted.

<System Architecture>

FIG. 16 shows the system architecture of this information system. As illustrated in FIG. 16, the information system is configured by the ISP 10 constructed of the Web server 1 and the proxy server 2, the ISP customer terminals 3A establishing a contract with the ISP 10 and transmitting a customer's own Web page via the Web server 1, the browsing user terminal 5 receiving the distribution of contents such as the Web pages and so on from the Web server 1, and service providing servers 4A, 4B for providing a variety of services on the Internet, which are all connected to each other via a network such as the Internet etc.

The service providing servers 4A, 4B provide the variety of services on the Internet. For example, each of the service providing servers 4A, 4B translate the Web page of the ISP customer as by the translation server 4 in the first embodiment, and so on.

The Web server 1 embeds a gateway (e.g., a button or a hyperlink) used for selecting whether the service is received from the service providing server 4A or 4B, into the Web page distributed to the browsing user. The browsing user selects the gateways (interfaces) and can enjoy the variety of services as well as browsing the Web page.

Further, the Web server 1 embeds display functions for information such as a news telop display function, a weather forecast display function, a stock price display function, an exchange rate display function and so forth, into the Web page distributed to the browsing user.

In this case, the ISP customer may not upload all the Web pages into the ISP 10. For instance, it is assumed that the ISP customer is a customer of other ISP 10A and has already uploaded the majority of Web pages into the ISP 10A. In this case, the ISP customer may register, e.g., a top page in the ISP 10. Then, as already explained in the first embodiment (FIGS. 12 etc), the link address to the top page is transferred to the program for embedding the gateway function and the display function, whereby the gateway function and the display function are embedded into Web pages subsequent to the top page. Through this procedure, the ISP customer is able to embed the gateway function and the display function into all the Web pages further hyperlinked from the top page.

Moreover, a change mode as a substitute for uploading the top page into the ISP 10 involves uploading a registration page registered in a search engine into the ISP 10. With this mode taken, the ISP customer is able to embed the gateway function and the display function into the Web pages further hyperlinked from the Web page searched from the search engine.

As in the first embodiment, the Browser 20 is implemented on the browsing user terminal 5 and displays the Web pages on the network. The Web server 1 embeds the display function and the gateway function into the Web page of the ISP customer establishing the predetermined contract.

When the browsing user selects (such as clicking by use of the pointing device etc) the gateway function, as in the first embodiment, the Browser 20 on the browsing user terminal detects this user's event. Then, the Browser 20 specifies the Web page (URL: Uniform Resource Locator) as a service providing target.

Moreover, the Browser 20, as by the information system in the first embodiment, obtains the URL as a link address (of the service providing server 4A etc) corresponding to the gateway function. Then, the Browser 20 transmits the URL of the service providing target Web page to the link address.

The service providing server 4A etc specifies the URL of the target Web page from the parameter received. Next, the service providing server 4A etc provides a predetermined service with respect to the Web page. The service is, for example, to translate the Web page and so forth.

In the second embodiment, a process for the Web server to embed the display function into the requested Web page and provide this function-embedded Web page to the browsing user in response to the request from the Browser 20, will hereinafter be called a “redirection”. Further, a process for the service providing server 4A etc to effect predetermined processing (such as translation and so forth) on the Web page requested by the Browser 20 and provide this Web page to the browsing user, is also called the “redirection”.

Moreover, such a behavior is called “redirect”. Further, a registration address (e.g., the ISP 10) of the source Web page that is redirected in the redirection described above is called a “redirect address”.

<Data Structure>

FIG. 17 shows the data structure of a redirect address table. The redirect address table is used for the Web server 1 to manage the Web page of the redirect address for every ISP customer.

Pieces of information (data) for managing one single ISP customer are stored in each line (one record) in this table. This record consists of pieces of data entered in a “user” field, a “self-site ID” field, a “redirect address” field and a “layout definition file” field.

The “user” field is stored with a character string (user's ID) for identifying each ISP customer. For instance, in the record of the ISP customer named Tanaka-san, a character string “Tanaka” is entered in the “user” field.

Further, the “self-site ID” field is stored with a character string specifying a storage site for storing the HTML source of the ISP customer in this ISP 10.

As by the information system in the first embodiment, the identity of each ISP customer is at first authenticated with the user's ID and the password by the ISP 10. Then, this authenticated ISP customer is allowed to upload the HTML source. The uploaded HTML source is retained in a site identified by the “self-site ID”. Normally, the URL of this Web page is defined such as ISP URL/“self-site” ID. For example, if the URL of the ISP is http://provider.co.jp/, the URL of the HTML source identified by “tanaka” entered in the “self-site ID” field in FIG. 17, is http://provoder.co.jp/tanaka.

The “redirect address” field is stored with the URL specifying the embedding target Web page into which the Web server 1 embeds the information display function and the service gateway function. The Web server, when displaying the Web page having this redirect address, embeds the information display function and the service gateway function into this Web page.

A name of a file that defines a screen layout on the Web page is specified in the “layout definition file” field. The screen layout is determined by a category of the screen layout, and a default file of the user is generated.

FIG. 18 shows a data structure of a service contract management table. The service contract management table defines a category of the information display function embedded into the Web page of each ISP customer and also a category of the gateway function embedded into this Web page. Note that the categories of the information display function and of the service gateway function embedded by the Web server 1 are also generically called a category of the service contract.

One record (each line) of this table consists of pieces of information for managing one single ISP customer. This record may be defined as a list of information or services provided by the ISP 10.

The services provided are, e.g., creating a text summary of the Web page, the translation service of the Web page as explained in the first embodiment, and so forth. The gateway function for requesting such a service is embedded into the Web page of the ISP customer establishing the predetermined contract with the ISP 10. Accordingly, the browsing user of this Web page is allowed to receive the service specified in this gateway function.

Further, the information provided includes stock prices, news, weather forecast and others. The display function for displaying this category of information is embedded into the Web page of the ISP customer establishing the predetermined contract with the ISP 10. Hence, the browsing user of this Web page is allowed to obtain the information specified in this display function.

<Screen Layout>

FIG. 19 shows the examples of the layouts of the screen when the present ISP 10 embeds information display functions and the service gateway functions into the Web page of the ISP customer. According to the second embodiment, the information display function and the service gateway function are embedded into predetermined regions (that will hereinafter be termed “frames”). Referring to FIG. 19, the hatching regions indicate the frames where the display function and the gateway function to be embedded are disposed.

Moreover, a blank space excluding the hatching regions is a space for the original Web page. A frame corresponding to the space for the original Web page is called a main frame.

Normally, the information display functions and the service gateway functions are embedded into upper, lower, left and right regions on the basis of the original Web page space. Further, the information display function and the service gateway function may be embedded into a set of such regions combined (which is called a frame set).

The Web server 1 has the layout definition file containing the definitions of those screen layouts. A position and dimensions of the main frame, names, positions and dimensions of the frames other than the main frame, and categories of the service contracts allocated to these frames, are defined in the layout definition file, and used for generating a default page of each ISP customer.

The Web server 1 in the second embodiment embeds, into the screen layouts shown in FIG. 19, for example, headline news (list, telop), stock price information (real time), exchange information (real time), information such as weather forecast etc, translation buttons (a variety of translated versions), a summary button, a text search, a live camera, a transfer search, an Internet search, map display, a BGM selection (no display on the screen) and others.

FIG. 20 illustrates an example of the Web page that is function-embedded by the Web server 1 of the ISP 10 (the original Web page is the same as that in FIG. 4).

The translation buttons 21 into Chinese, Hankul and English versions (which are identified by marks of the national flags of the respective countries) and the news telop 22, are displayed on this Web page. The browsing user clicks the translation button 21, whereby the Web page is translated into the language specified by this button as in the first embodiment. News is displayed in real time in the news telop 22.

Note that the information display function is prepared with, excluding the news telop 22 and others, a display box (e.g., a stock price display box) for displaying the information in real time, a weather forecast display box, and an information list containing plural items of summarized information (e.g., a headline list of the news).

<Structure of HTML File>

FIG. 21 shows an example of the HTML source describing the Web page (FIG. 20) into which the translation buttons 21 and the news telop 22 are embedded. Note that the HTML source of the original Web page is the same as that in the first embodiment (FIG. 8), and therefore its repetitive explanation is omitted.

A frame set consisting of two pieces of frames is defined in lines 201, 202 within a set of tags <FRAMESET> and </FRAMESET> in the HTML source shown in FIG. 21. Herein, the frames are defined as areas for displaying the information and the service gateway on the Web page. In the frame set, “toplFrame” (line 201) and “toprFrame” (line 202) are defined.

A parameter “svc=trans” is specified in “toplFrame” in line 201, whereby a program “services.cgi” is executed. With this execution, the program “services.cgi” displays, in “toplFrame”, the translation buttons 21 illustrated in FIG. 20. The details of the program that displays the translation buttons 21 are the same as those in the first embodiment (FIG. 9), and hence the repetitive explanation is omitted.

Further, a parameter “svc=news” is specified in “toprFrame” in line 202, whereby the program “services.cgi” is likewise executed. With this execution, the program “services.cgi” lays out, in “toprFrame”, the news telop 22 illustrated in FIG. 20, thereby displaying the news in real time.

Note that FIG. 21 shows the HTML source embedded with the translation button 21 as the service gateway function. The service gateway function embedded in the present information system is not, however, limited to the translation button 21. For example, a search specifying box to the search engine and a summary button for creating a summary of the Web page may also be embedded.

Further, FIG. 21 shows the news telop 22 by way of an example of the information display function, however, the information display function embedded by the Web server 1 is not confined to the telop. For instance, a list of news headlines may be displayed, and the stock prices may also be displayed in real time.

Moreover, in the HTML source shown in FIG. 21, a frame “mainFrame” is defined (LINE 203) under the frame set (FRAMESET) A site (http://provider2.ne.jp/tanaka) of the content created by the ISP customer is specified as a parameter in “mainframe”, and a program “redirect.cgi” is started.

The program “redirect.cgi” is a program for laying out the Web page specified by the parameter in the space specified by the frame “mainFrame”. With such a process executed, the Web page of the ISP customer is displayed in combination with the translation buttons 21 and the telop 22.

Further, as in the first embodiment, the URL as a link address contained in the Web page of the ISP customer is transferred to the program “redirect.cgi” as indicated in line 203, whereby the Web page specified by this link address is laid out in the frame “mainframe”. Thus, the information display function (such as the news telop 22, etc) and the service gateway function (such as the translation button 21, etc) can be embedded into all the Web pages subsequent to the Wen page of the ISP customer.

In the process of displaying the Web page in “mainFrame” described above, the original Web page (redirect address) may also be what is uploaded into an ISP other than the ISP 10. Namely, the Web page uploaded to other provider may be defined as a redirect address in the main frame shown in FIG. 21.

Further, the ISP other than the ISP 10 may retain the program “redirect.cgi” for executing “redirect” or the program “services. cgi” for providing the information or service display function.

<Operation>

FIG. 22 shows a flow of processing of obtaining the information from and embedding a function into the original Web page in the present information system.

To start with, the browsing user terminal 5 transmits the URL of the content to be displayed to the server (S20). Then, the Web server 1 searches for the ISP customer having uploaded the content of the requested page on the basis of this transmitted URL.

Note that this URL is given in a form such as default.cgi?user=tanaka (incidentally, a description of this URL is omitted), wherein a code element after “?” is transferred to a program “default.cgi”. Herein, the program “default.cgi” recognizes a piece of information specified by “user” as an ID (“tanaka” in this example) of the ISP customer from the parameter transferred. Further, this program recognizes that the member database (that is the same as that in FIG. 10) contains the ID of the ISP customer by referring this member database.

After recognizing that the ID of the ISP customer exists therein, the Web server 1 generates a default page of this ISP customer (S21).

Next, the Web server 1 executes Scrip within the default page (S22, which corresponds to the execution specified in line 203 in FIG. 21). CGI (Common Gateway Interface) for executing “redirect” is thereby started.

Next, CGI executing redirect” obtains a URL of the content from the parameter specified when started (S23). Then, CGI executing “redirect” obtains a content specified by the URL specified by the parameter (S24).

Subsequently, CGI executing “redirect” replaces a link address contained in the obtained content with an invocation of Script (CGI) (S25). This is a process of replacing, e.g., href=X in the tag set <A>, </A> of the HTML source with href=redirect.cgi?URL=X. An effect of this replacement has been explained in line 203 in FIG. 21.

Next, the Web server 1 embeds the service information into the content on the basis of the service contract management table for every contractor (S26). This process is to embed, e.g., the translation buttons 21 and the news telop 22, and so forth.

Then, the Web server 1 transmits the content of the requested Web page to the browsing user (S27).

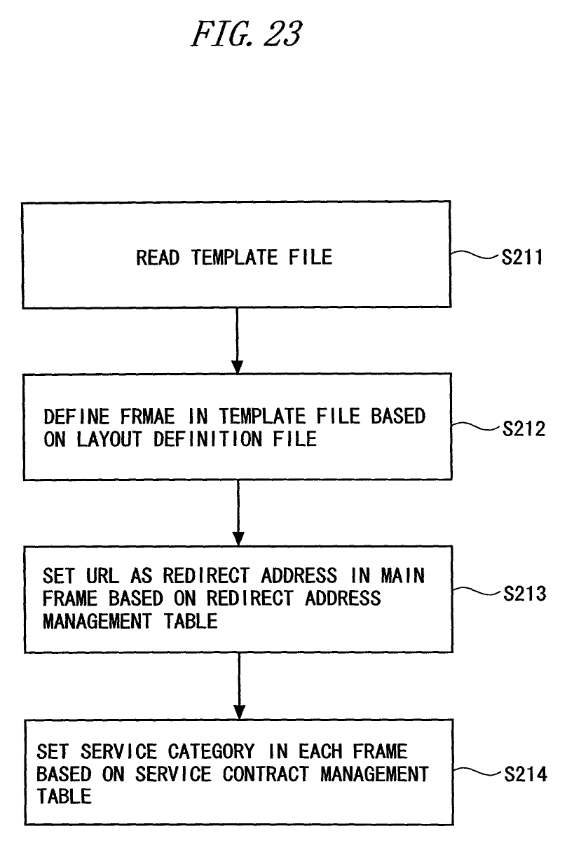

FIG. 23 shows details of a default page generation process (S21 in FIG. 22). In this process, to begin with, the Web server 1 reads a template file for creating the default page (S211). A predetermined header (definitions of the character sets, and so on) is set in the template file.

Subsequently, the Web server 1 defines the frames in the template file in accordance with the layout definition file (S212).

Next, the Web server 1 sets a URL as a redirect address in the main frame in accordance with the redirect address table (S213).

Next, the Web server 1 sets a service category in each frame in accordance with the service contract management table, and generates the default page corresponding to the ISP customer (S214).

<Effects of Embodiment>

As discussed above, according to the information system in the second embodiment, the information display functions and the service gateway functions are embedded into the Web page of the ISP customer having a desire for transmitting the Web page. Hence, a usability of the Web page created by the ISP customer can be enhanced in the ISP 10. As a result, the number of the users who browse the Web page can be increased.

Further, according to the second embodiment, “redirect” is executed on the hyperlink within the Web page into which the information display function and the service gateway function are embedded, whereby the information display function and the service gateway function can be embedded into the Web page hyperlinked to the above Web page.

Moreover, according to the second embodiment discussed above, the default page displayed at first on the Web page of the ISP customer is uploaded into the ISP 10, and the ISP customer receives the service for embedding the information display function and the service gateway function, whereby the information display function and the service gateway function can be similarly embedded into the Web pages registered in other ISPs.

Further, according to the second embodiment, the ISP customer may request the ISP 10 to select the embedding target information display function and service gateway function for every customer and to set these function in the default page.

<Collection of Fees for Use>

In the case of providing the services described above through the Web page on the Internet, the ISP 10 normally can charge a fee on the ISP customer providing the Web page. Further, the ISP 10 can collect a variety of fees from the users other than the ISP customers. The followings are types of fees collected by the ISP 10 and collecting methods.

(1) The ISP 10 uniformly charges a fee on the user (owner of the content displayed). For instance, this is a method of collecting 100 yen per month from each user.

(2) The ISP 10 provides the present service to all the members without collecting any special fees. In the example explained previously, the service of embedding the buttons into the Web page is executed for only the members each establishing the option contract, however, this service is provided to the members according to the basic contract without requiring any special contract. With this contrivance, an increase in the number of new members can be prospective.

(3) The ISP 10 acquires an income of the advertisement from a sponsor by putting the advertisement into the customizing area. The ISP 10 is thereby capable of increasing an access count by making its use free of charge.

(4) The ISP 10 collects the fee from the service provider. When the service gateway function is embedded into the Web page, there increases the access count to the service provider who provides this service. The ISP 10 assures the access count within a predetermined range, and instead demands for its fee.

(5) The ISP 10 collects the fees from other ISPs. Namely, the ISP 10 obtains license fees by providing other ISPs with the program for actualizing the Web server 1.

(6) There might be a case where the ISP 10 does not collect the fee. In this case, the ISP 10 can differentiate from other ISPs by providing the above service free of charge.

(7) The ISP 10 provides the service by linking it with brokerage of obtaining a domain name. For example, there can be advertised a copy saying that “if you obtain a domain through our company, you may put our service in your page”.

<Modified Example>

According to the second embodiment, the information display function and the service gateway function are embedded into the Web page of the ISP customer transmitting the Web page on the Internet. The embodiment of the present invention is not, however, limited to the architecture and operation described above. For instance, the functions of the information system in the second embodiment may be provided through, e.g., private networks like Intranet etc within specific organizations such as enterprises, educational institutions (schools), corporations, associations and so on. Namely, the information display function may be embedded into the intra-organization Web page by the intra-organization Web server 1. For example, there may be added the information display function for notices to organization members like employees and for messages from a manager to managees. In this case, a intra-organization service management table having the same data structure as shown in FIG. 18 is provided, and the information display function and the service gateway function to be embedded may be managed for every intra-organization user.

In the second embodiment discussed above, if the Web page requested from the Browser 20 is identical with the Web page of the ISP customer establishing the predetermined contract with the ISP 10, the information display functions and the service gateway functions are embedded into this Web page. The embodiment of the present invention is not, however, restricted to the architecture and operation described above.

For example, the proxy server 2 may embed the information display function and the service gateway function into the Web page. In this case, as done in the first embodiment, the proxy server 2 may retain the management information recorded in the redirect address table (FIG. 17),the service contract management table (FIG. 18) and the layout definition file for defining the layouts on the unillustrated screen.

Then, the proxy server 2 confirms the information of the Web page transmitted to the browsing user terminal 5 from the Web server 1, and may, if the information of the Web page is identical with the information provided by the ISP customer establishing the predetermined contract, embed the information display function and the service gateway function into this Web page by referring to the redirect address table, the service contract management table and the layout definition file for defining the screen layouts.

<<A Storage Medium Readable by a Machine>>

The program executed by a computer to function as the Web server 1 or the proxy server 2 may be recorded on a storage medium readable by a machine. Then, the machine reads and executes the program on this storage medium, thereby functioning as the Web server 1 or the proxy server 2.

Herein, the storage medium readable by a machine embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<<Data Communication Signal Embodied in Carrier Wave>>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to function as the Web server 1 or the proxy server 2 described above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be anyone of a modulated broadband signal and an unmodulated base band signal (corresponding to a case of setting a DC signal having a voltage of 0 as a carrier wave).

What is claimed is:

1. A server comprising:
a communication module receiving request information from a terminal device on a network, and transmitting display information for specifying a display content on said terminal device; and
an embedding module embedding information display functions for displaying information provided on said network or service gateway functions to services provided on said network, into the display content.

2. A server according to claim 1, wherein said embedding module embeds definition information for defining the information display function or the service gateway function, into the display information, and
said communication module transmits the display information embedded with the definition information to said terminal device.

3. A server according to claim 2, wherein the service gateway function is a gateway function to a service of translating the display content.

4. A server according to claim 3, wherein said embedding module embeds a translation indicating area in which a translation language can be specified from a plurality of languages.

5. A server according to claim 1, further comprising a contract condition management module managing a contract condition with a provider of the information,
said embedding module embedding the information display function or the service gateway function into the information given from said provider establishing a contract under a predetermined contract condition.

6. A server according to claim 2, further comprising an information management module managing data about said provider of the information and about a storage site of the information,
said embedding module embedding the information display function or the service gateway function into content of the information given from said provider, which is obtained by accessing the storage site.

7. A relay device comprising:
a communication module relaying display information, transmitted from a server to a terminal device in response to request information given to said server from said terminal device, for specifying a display content on said terminal device; and
an embedding module embedding information display functions for displaying information provided on a network or service gateway functions to services provided on said network, into the display content.

8. A relay device according to claim 7, wherein said embedding module embeds definition information for defining the information display function or the service gateway function, into the display information, and
said communication module transmits the display information embedded with the definition information to said terminal device.

9. A relay device according to claim 8, wherein the service gateway function is a gateway function to a service of translating the display content.

10. A relay device according to claim 9, wherein said embedding module embeds a translation indicating area in which a translation language can be specified from a plurality of languages.

11. A relay device according to claim 7, further comprising a contract condition management module managing a contract condition with a provider of the information,
said embedding module embedding the information display function or the service gateway function into the information given from said provider establishing a contract under a predetermined contract condition.

12. A relay device according to claim 7, further comprising an information management module managing data about said provider of the information and about a storage site of the information,
said embedding module embedding the information display function or the service gateway function into content of the information given from said provider, which is obtained by accessing the storage site.

13. An information providing method, of providing information, said method comprising:
receiving request information from a terminal device; and
transmitting display information for specifying a display content on said terminal device in response to the request information,
wherein said transmitting the display information involves embedding information display functions for displaying information provided on a network or service gateway functions to services provided on said network, into the display content.

14. An information providing method according to claim 13, wherein said embedding the display function or gateway function involves embedding definition information for defining the information display function or the service gateway function, into the display information.

15. An information providing method according to claim 14, wherein the service is a service of translating the display content.

16. An information providing method according to claim 15, wherein said embedding the display function or the gateway function involves embedding a translation indicating area in which a translation language can be specified from a plurality of languages.

17. An information providing method according to claim 13, further comprising referring to a contract condition management information for managing a contract condition with a provider of the information,
wherein said embedding involves embedding the information display function or the service gateway function into the information given from said provider establishing a contract under a predetermined contract condition.

18. An information providing method according to claim 13, further comprising managing data about said provider of the information and about a storage site of the information,
wherein said embedding involves embedding the information display function or the service gateway function into the information given from said provider, which is obtained by accessing the storage site.

19. A relay method, of relaying a server and a terminal device, said method comprising:
relaying display information, transmitted from said server to a terminal device in response to request information given to said server from said terminal device, for specifying a display content on said terminal device; and
embedding information display functions for displaying information provided on a network or service gateway functions to services provided on said network, into the display content.

20. A relay method according to claim 19, wherein said embedding the display function or the gateway function involves embedding definition information for defining the information display function or the service gateway function, into the display information.

21. A relay method according to claim 20, wherein the service is a service of translating the display content.

22. A relay method according to claim 21, wherein said embedding the display function or the gateway function involves embedding a translation indicating area in which a translation language can be specified from a plurality of languages.

23. A relay method according to claim 19, further comprising referring to a contract condition management information for managing a contract condition with a provider of the information,
wherein said embedding involves embedding the information display function or the service gateway function into the information given from said provider establishing a contract under a predetermined contract condition.

24. A relay method according to claim 19, further comprising managing data about said provider of the information and about a storage site of the information,
wherein said embedding involves embedding the information display function or the service gateway function into the information given from said provider, which is obtained by accessing the storage site.

25. A storage medium readable by a machine, tangible embodying a program of instructions executable by the machine to perform method steps for making a computer provide information, the method steps comprising:
receiving request information from a terminal device; and
transmitting display information for specifying a display content on said terminal device in response to the request information,
wherein said transmitting the display information involves embedding information display functions for displaying information provided on a network or service gateway functions to services provided on said network, into the display content.

26. A storage medium readable by a machine tangible embodying a program according to claim 25, wherein embedding the display function or gateway function involves embedding definition information for defining the information display function or the service gateway function, into the display information.

27. A storage medium readable by a machine tangible embodying a program according to claim 26, wherein the service is a service of translating the display content.

28. A storage medium readable by a machine tangible embodying a program according to claim 27, wherein said embedding the display function or the gateway function involves embedding a translation indicating area in which a translation language can be specified from a plurality of languages.

29. A storage medium readable by a machine tangible embodying a program according to claim 25, the method steps further comprising referring to a contract condition management information for managing a contract condition with a provider of the information,
wherein said embedding involves embedding the information display function or the service gateway function into content of the information given from said provider establishing a contract under a predetermined contract condition.

30. A storage medium readable by a machine tangible embodying a program according to claim 25, the method steps further comprising managing data about said provider of the information and about a storage site of the information,
wherein said embedding involves embedding the information display function or the service gateway function into content of the information given from said provider, which is obtained by accessing the storage site.

31. A storage medium readable by a machine, tangible embodying a program of instructions executable by the machine to perform method steps for making a computer relay a server and a terminal device, the method steps comprising:
relaying display information, transmitted from said server to a terminal device in response to request information given to said server from said terminal device, for specifying a display content on said terminal device; and
embedding information display functions for displaying information provided on a network or service gateway functions to services provided on said network, into the display content.

32. A storage medium readable by a machine tangible embodying a program according to claim 31, wherein said embedding the display function or the gateway function involves embedding definition information for defining the information display function or the service gateway function, into the display information.

33. A storage medium readable by a machine tangible embodying a program according to claim 32, wherein the service is a service of translating the display content.

34. A storage medium readable by a machine tangible embodying a program according to claim 33, wherein said embedding the display function or the gateway function involves embedding a translation indicating area in which a translation language can be specified from a plurality of languages.

35. A storage medium readable by a machine tangible embodying a program according to claim 31, the method steps further comprising referring to a contract condition management information for managing a contract condition with a provider of the information,
wherein said embedding involves embedding the information display function or the service gateway function into content of the information given from said provider establishing a contract under a predetermined contract condition.

36. A storage medium readable by a machine tangible embodying a program according to claim 31, the method steps further comprising managing data about said provider of the information and about a storage site of the information,
wherein said embedding involves embedding the information display function or the service gateway function into content of the information given from said provider, which is obtained by accessing the storage site.

37. A system comprising:
a first server including: a communication module receiving request information from a terminal device on a network, and transmitting display information for specifying a display content on said terminal device; and an embedding module embedding information display functions for displaying information provided on said network or service gateway functions to services provided on said network, into the display content; and
a second server providing a service specified by a display content on said terminal device via a network.

38. A system according to claim 37, wherein said embedding module embeds definition information for defining the information display function or the service gateway function, into the display information, and
said communication module transmits the display information embedded with the definition information to said terminal device.

39. A system according to claim 38, wherein the service gateway function is a gateway function to a service of translating the display content.

40. A system according to claim 39, wherein said embedding module embeds a translation indicating area in which a translation language can be specified from a plurality of languages.

41. A system according to claim 37, wherein said first server further includes a contract condition management module managing a contract condition with a provider of the information,
said embedding module embedding the information display function or the service gateway function into content of the information given from said provider establishing a contract under a predetermined contract condition.

42. A system according to claim 38, wherein said first server further includes an information management module managing data about said provider of the information and about a storage site of the information,
said embedding module embedding the information display function or the service gateway function into the information given from said provider, which is obtained by accessing the storage site.
